(19) United States
(12) Patent Application Publication
(10) Pub. No.: US 2022/0036451 A1
(43) Pub. Date: Feb. 3, 2022

(54) RELATIONSHIP-BASED TRANSACTIONS AND PEER TO PAY TRANSACTIONS

(71) Applicant: Zirtue, LLC, Dallas, TX (US)

(72) Inventor: Dennis CAIL, Dallas, TX (US)

(73) Assignee: ZIRTUE, LLC, Dallas, TX (US)

(21) Appl. No.: 17/352,036

(22) Filed: Jun. 18, 2021

Related U.S. Application Data
(60) Provisional application No. 63/060,490, filed on Aug. 3, 2020.

(51) Int. Cl. G06Q 40/02; G06Q 20/10

(52) U.S. Cl. CPC G06Q 40/025; G06Q 20/10

(57) ABSTRACT

An information handling system may include at least one processor; and a non-transitory memory coupled to the at least one processor. The information handling system may be configured to: receive, from a borrowing party, a request for a loan from a lending party for servicing a debt owed to a creditor party; transmit, to the lending party, information relating to the request; determine loan repayment terms; cause a first amount of funds to be debited from the lending party in a first transaction; and cause a second amount of funds to be credited to the creditor party in a second transaction.

### CROSS-REFERENCE TO RELATED APPLICATIONS

This application claims priority to U.S. Provisional Patent Application No. 63/060,490, filed Aug. 3, 2020, which is incorporated by reference herein in its entirety.

### TECHNICAL FIELD

The present disclosure relates in general to information handling systems, and more particularly to the use of information handling systems in transactions such as lending and bill payment transactions.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Embodiments of this disclosure may use information handling systems in the field of financial transactions such as borrowing and lending, particularly among friends, family, and trusted relationships with terms that may be set by the lender and/or borrower. Embodiments may provide a platform referred to as Zirtue for enabling such transactions.

Americans currently borrow over $184 billion annually from friends and family, and consumer debt reached $4 trillion as of 2018. Some 137 million Americans are struggling with medical debt. Many consumers suffer from limited access to banks and traditional lending options, and there has so far been no solution available to automate loan repayment to friends and family.

This leads to an inefficient process for borrowing and lending, awkward relationships as repayment is sought, etc. Many borrowers may already be overdrawn, and so they may not have a usable checking account in which to receive the loan funds. Further, many lenders may be reluctant to lend money to help someone with a bill without some assurance that the money will actually go toward that bill.

Embodiments of this disclosure may thus improve on existing solutions.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with borrowing and lending may be reduced or eliminated.

In accordance with embodiments of the present disclosure, an information handling system may include at least one processor; and a non-transitory memory coupled to the at least one processor. The information handling system may be configured to: receive, from a borrowing party, a request for a loan from a lending party for servicing a debt owed to a creditor party; transmit, to the lending party, information relating to the request; determine loan repayment terms; cause a first amount of funds to be debited from the lending party in a first transaction; and cause a second amount of funds to be credited to the creditor party in a second transaction.

In accordance with these and other embodiments of the present disclosure, various corresponding methods and/or articles of manufacture comprising non-transitory computer-readable media are also specifically contemplated.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates an example method, in accordance with embodiments of the present disclosure;

FIG. 3 illustrates a block diagram, in accordance with embodiments of the present disclosure;

FIG. 4 illustrates an example method, in accordance with embodiments of the present disclosure;

FIG. 5 illustrates an example method, in accordance with embodiments of the present disclosure; and

FIGS. 6, 7A-7H, and 8A-8H illustrate example user interface screens, in accordance with embodiments of the present disclosure.

### DETAILED DESCRIPTION

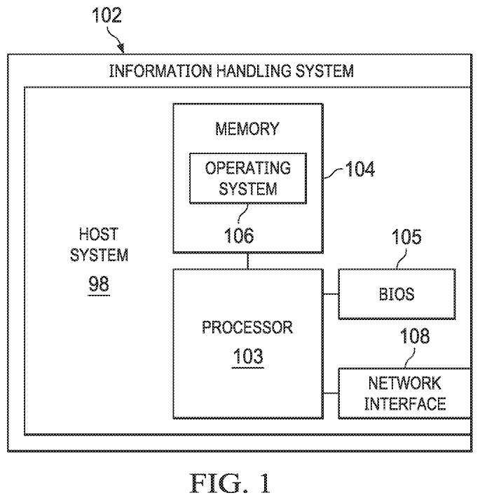

Preferred embodiments and their advantages are best understood by reference to FIGS. 1 through 8, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Various embodiments of this disclosure (or portions of such embodiments) may be implemented via an information handling system such as information handling system 102. As discussed above, embodiments of this disclosure may provide improvements in the field of borrowing and lending among friends, family, and other acquaintances. The loan repayment process may be automated, and real-time integration with corporate partners may enable direct payments from the lender to the creditor(s) of the borrower.

Embodiments may provide a formalized system and method for relationship-based lending that takes the awkwardness out of lending and borrowing money with friends and family. Users may select their lender or borrower directly from their contacts in their mobile device (e.g., smartphone) in some embodiments. Lenders may have the option to pay bills directly to the borrower's creditors from a mobile app using borrowed money from friends and family. This arrangement may also drive business profits for creditors that integrate with the app's lending platform, while decreasing write-offs and late payments, as well as providing an alternative payment solution for creditors and debtors.

In some embodiments, such lending may be used to service existing debts (e.g., a borrower may need assistance paying rent, car payments, medical debt or a utility bill). In other embodiments, such lending may be used to service debts that are created on-the-fly (e.g., a borrower may need assistance paying a restaurant for a meal that has just been eaten or while shopping). In either case, a lender may use the platform to pay the creditor directly.

Embodiments may provide an easy and secure way to send borrowed funds or payments to any creditor. The traditional, inefficient offline process may be mobilized and automated to provide a viable alternative payment solution to drive a better customer experience while decreasing corporate write-offs while eliminating consumer debt defaults and service disconnections.

For example, traditionally, a borrower might ask a friend for a loan to pay a bill to a creditor, but the lender may have no way of ensuring that the loan actually gets used for that purpose. Embodiments may remove such uncertainty by allowing the lender to pay the creditor directly.

A lending platform according to this disclosure may provide the ability to request and repay loans with anyone in a mobile device's contacts (e.g., via one or more integrated payment processing networks). Real-time integration with creditors may allow for direct and reliable repayment of funds. The borrower may have the capability to set the loan amount, while the lender may establishes the legally binding repayment terms. In some embodiments, the borrower may suggest initial repayment terms, which the lender may agree to or request to modify. When the terms are agreeable to both parties, the loan request may be formalized, enabling users to digitize and mobilize loans between friends, family, and other trusted relationships.

Users may register with the lending platform by providing various items of information (e.g., social security number, photo ID, date of birth, etc.). Users may also connect the platform to any of various payment methods (e.g., a bank account, a credit/debit card, a cryptocurrency wallet, a money transfer app, or any other suitable method).

Once registered, users may connect with other users who are in a contact list of a mobile device, allowing immediate access to friends and family. If a particular contact is not yet a member of the lending platform, a user may opt to send that contact an invitation to join the platform.

In some embodiments, a user may select one or more backup parties for the loan. For example, a borrower may select more than one potential lender, indicating in some embodiments the preferred order in which such lenders should be contacted regarding the loan. In this way, if a particular lender declines to make the loan, the platform may automatically contact the next backup lender.

In some embodiments, voice and/or video may be integrated into the process. This may allow friends and family to personalize the loan request prior to its delivery. The platform may in some embodiments convert such voice and/or video data into a digital loan request or loan offer, using speech-to-text technology.

A loan may be structured so that the initial loan is auto-drafted from the lender via a linked payment method. Monthly payments may then automatically be made to repay the loan via a linked payment method of the borrower. The lender and borrower may select desired loan terms (e.g., repayment timeline, interest, and any other desired terms), and the lending platform may automatically generate the repayment schedule.

In some embodiments, during the loan repayment period, the users may have the ability to create modifications to the repayment terms. For example, a borrower may request to defer a payment, and the lender may accept or decline that change. In these and other embodiments, a lender may have the option of forgiving the remaining loan balance in whole or in part.

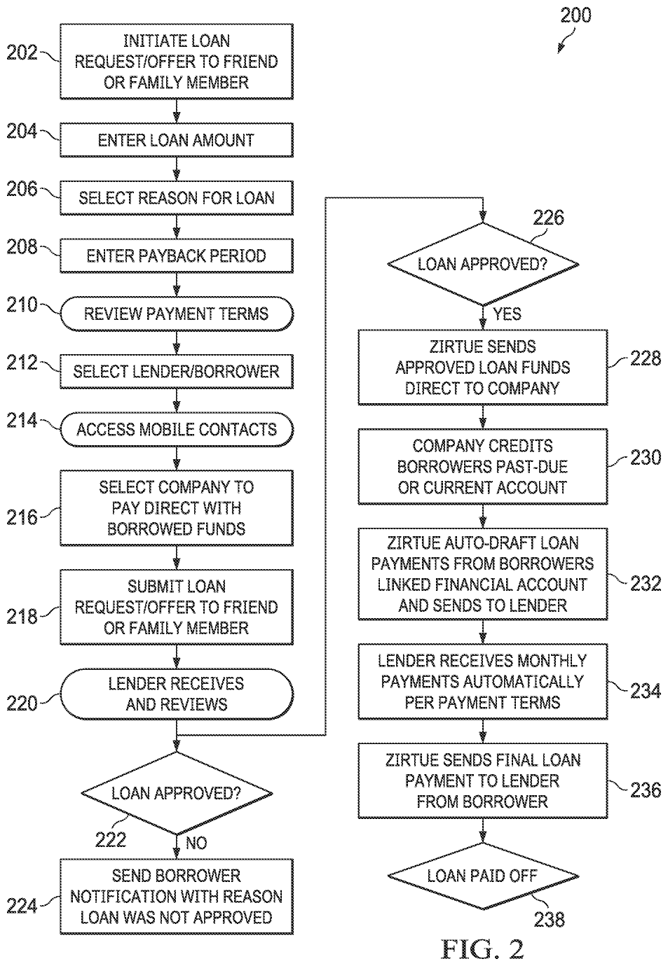

Turning now to FIG. 2, a flow chart is shown of an example method 200, in accordance with some embodiments of this disclosure. In some embodiments, some or all of the steps of method 200 may be carried out by one or more information handling systems. For example, some steps may be carried out by information handling system associated with a lending platform, while some other steps may be carried out at a mobile device of a user of such a platform.

At step 202, a borrower (or lender) may initiate a loan request. At steps 204-208, various details such as a loan amount, a reason for the loan, a payback period, etc. may be entered. The borrower (or lender) may review the payment terms at step 210 and select a lender (or borrower) at step 212 by accessing a contact list of a mobile device at step 214.

In some embodiments, a creditor company may be selected at step 216, such that the loan amount is transferred directly to the creditor instead of to the borrower.

At step 218, the loan request (or offer) may be submitted to the lender (or borrower), who may review the request at step 220. If the loan is not approved at step 222, then a notification is sent at 224 with reasons for the denial.

If the loan is approved at step 226, then the platform may send the funds directly to the creditor company at step 228. The creditor company may then credit the borrower's account at step 230.

At step 232, the platform may auto-draft loan repayments from the borrower's linked payment method and transfer them to the lender, who receives them at step 234. At step 236, the final loan repayment is sent, and the loan is paid off at step 238.

One of ordinary skill in the art with the benefit of this disclosure will understand that the preferred initialization point for the method depicted in FIG. 2 and the order of the steps comprising that method may depend on the implementation chosen. In these and other embodiments, this method may be implemented as hardware, firmware, software, applications, functions, libraries, or other instructions. Further, although FIG. 2 discloses a particular number of steps to be taken with respect to the disclosed method, the method may be executed with greater or fewer steps than depicted. The method may be implemented using any of the various components disclosed herein (such as the components of FIG. 1), and/or any other system operable to implement the method.

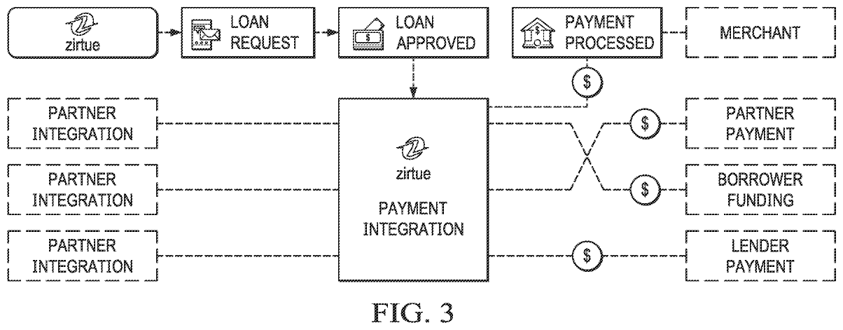

Turning now to FIG. 3, a high-level block diagram is shown of one embodiment of a lending platform, in accordance with embodiments of the present disclosure. FIG. 3 illustrates various types of parties that may integrate with the Zirtue lending platform.

In some embodiments, integration may be facilitated via a party's website. For example, JavaScript code may be inserted into the party's website to allow creation of a button that interacts with the lending platform.

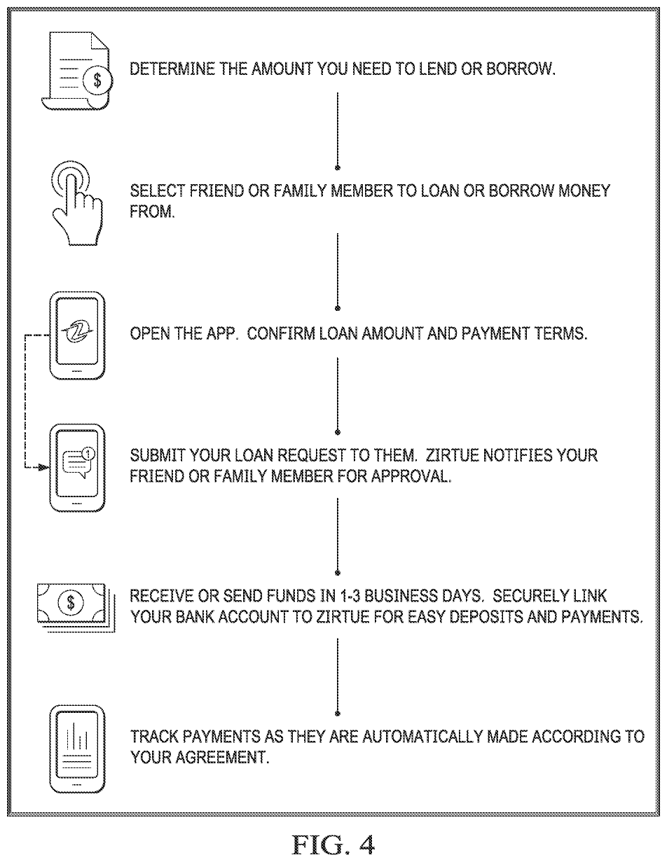

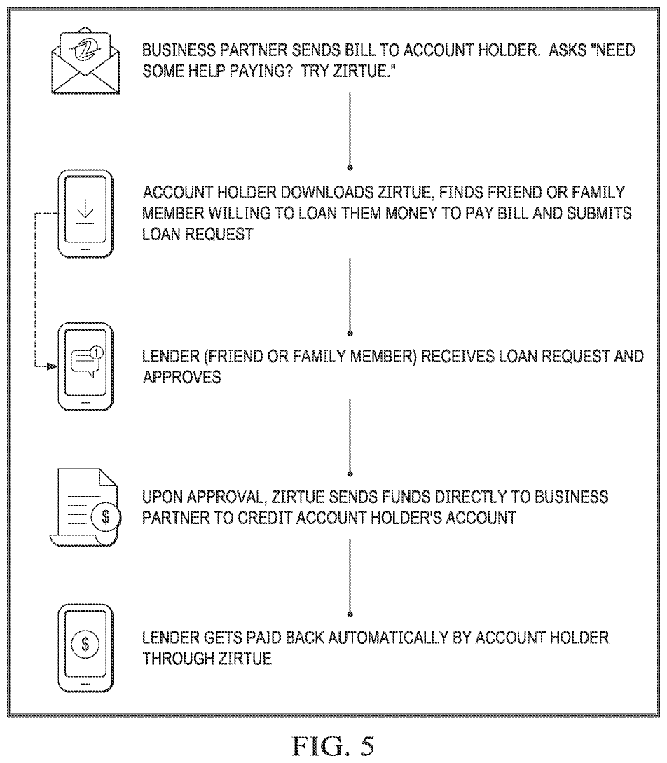

Turning now to FIGS. 4 and 5, flow charts are shown of an example methods that may be carried out by users of the platform, according to some embodiments.

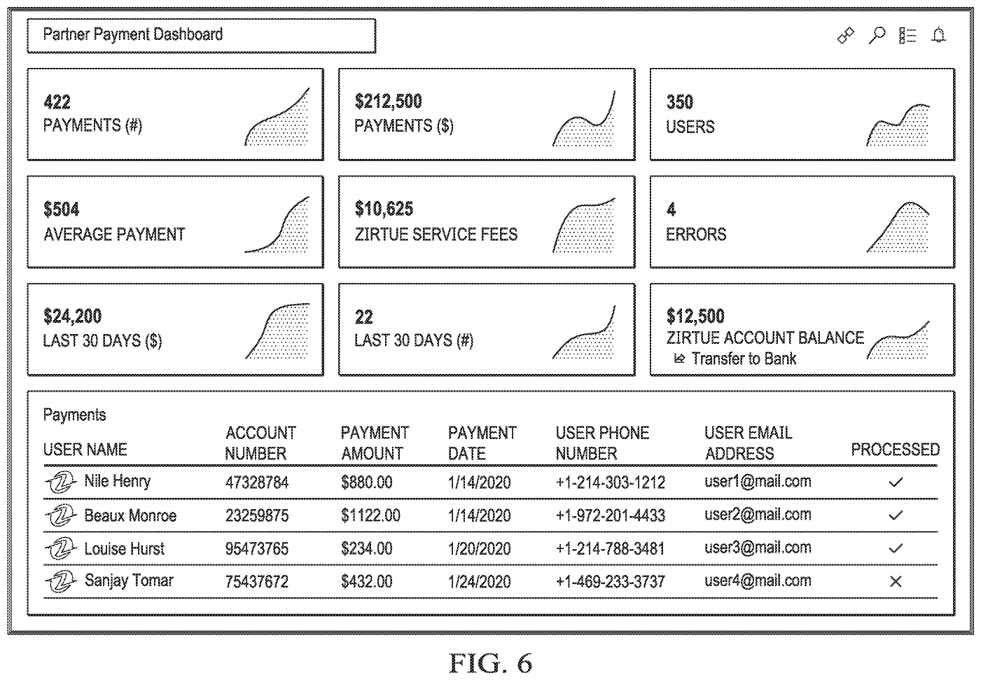

Turning now to FIG. 6, an example user interface is shown depicting an embodiment of a partner payment dashboard. A user interface as shown in FIG. 6 may be displayed to a partner company (e.g., a creditor that receives payments directly from lenders).

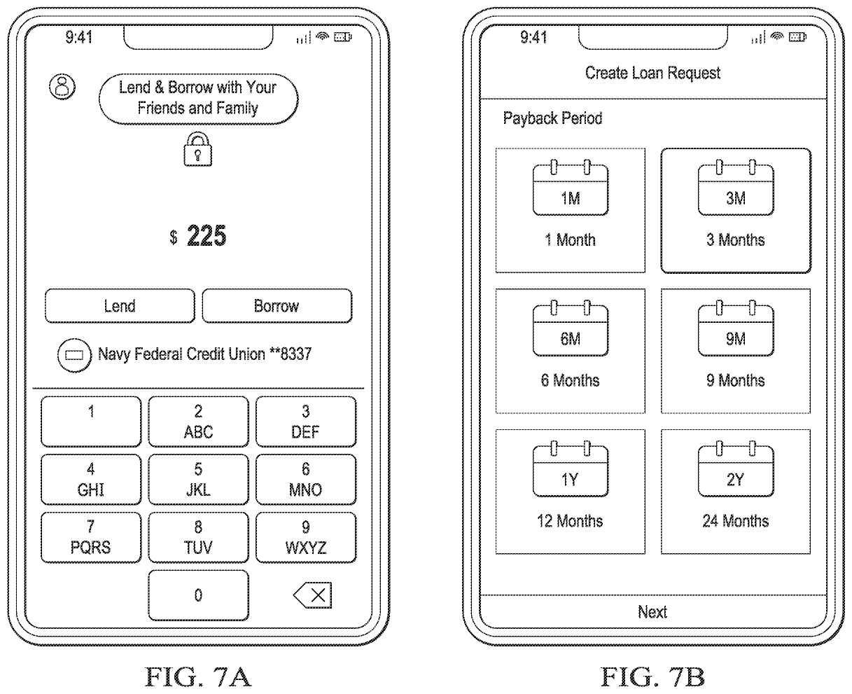

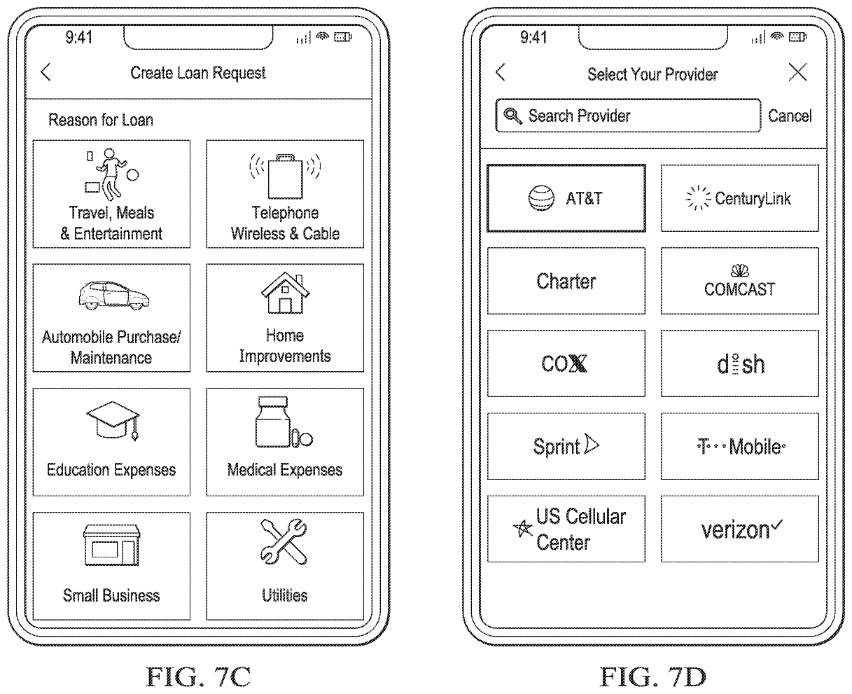

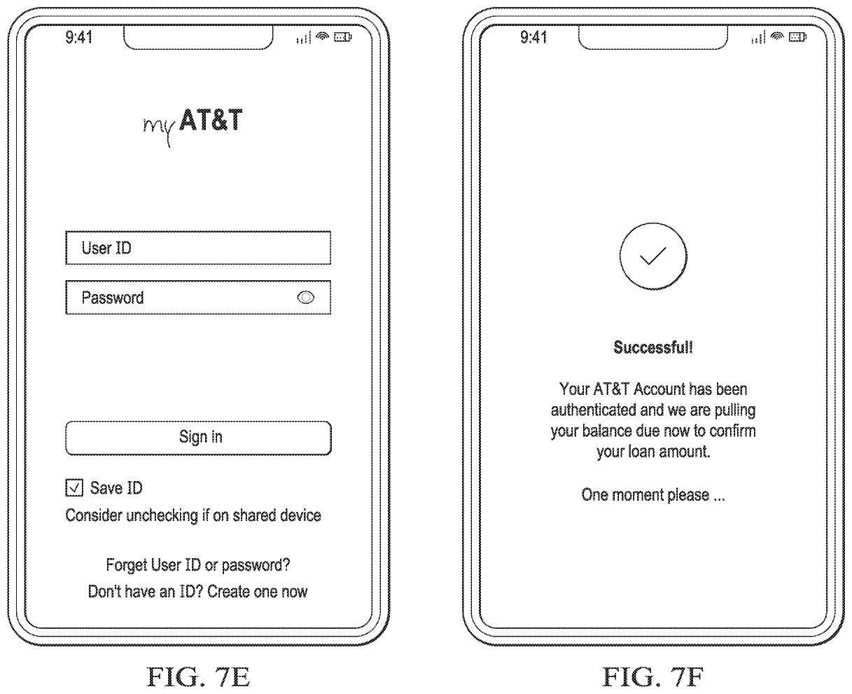

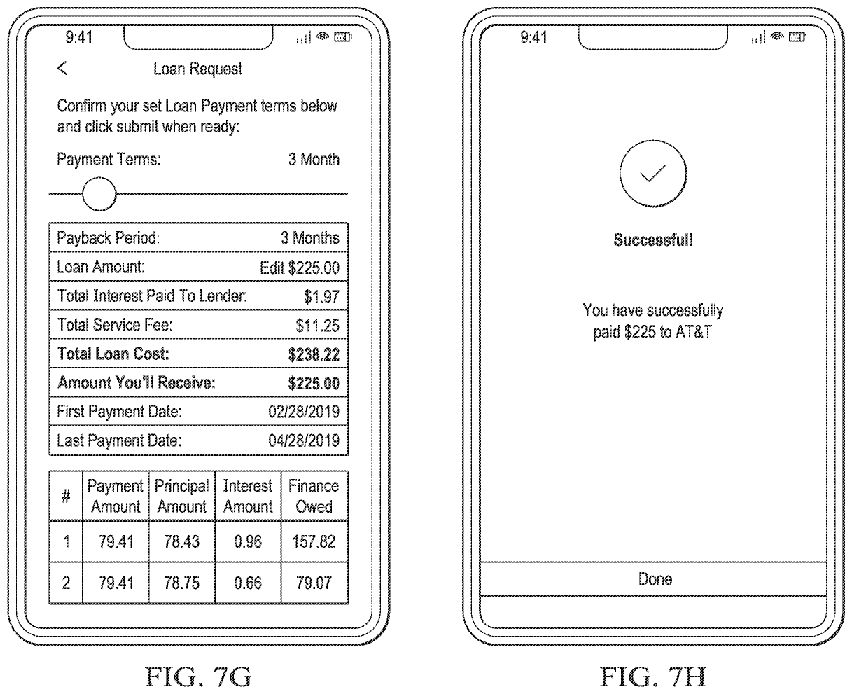

Turning now to FIGS. 7A-7H, a set of example user interfaces are shown depicting an embodiment of a borrower's use of an app, in accordance with some embodiments.

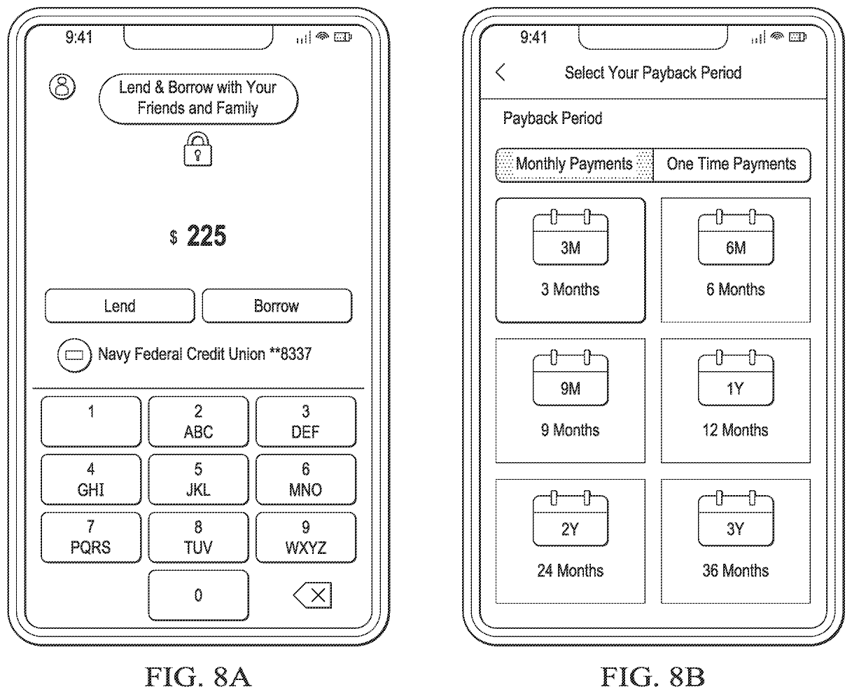

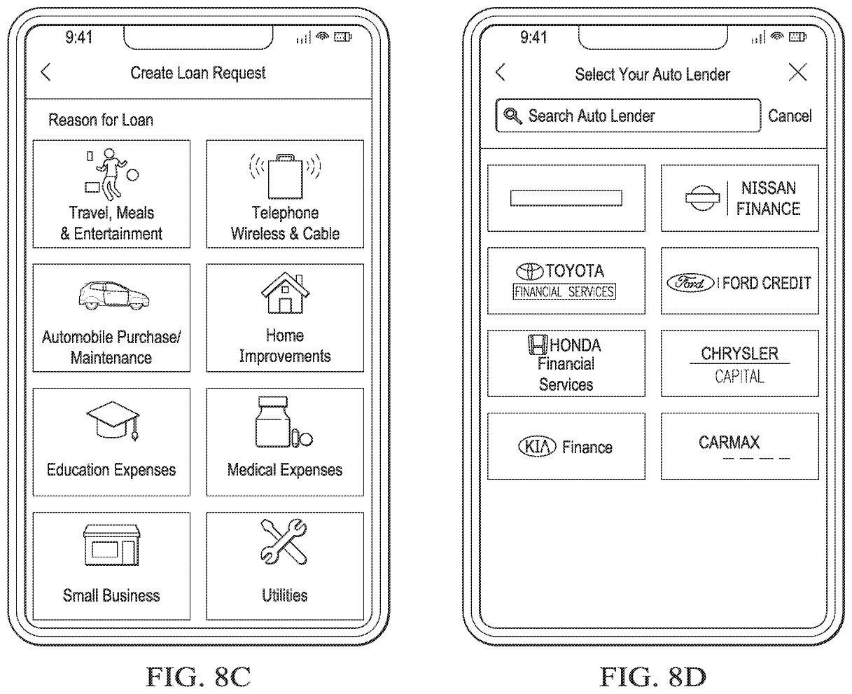

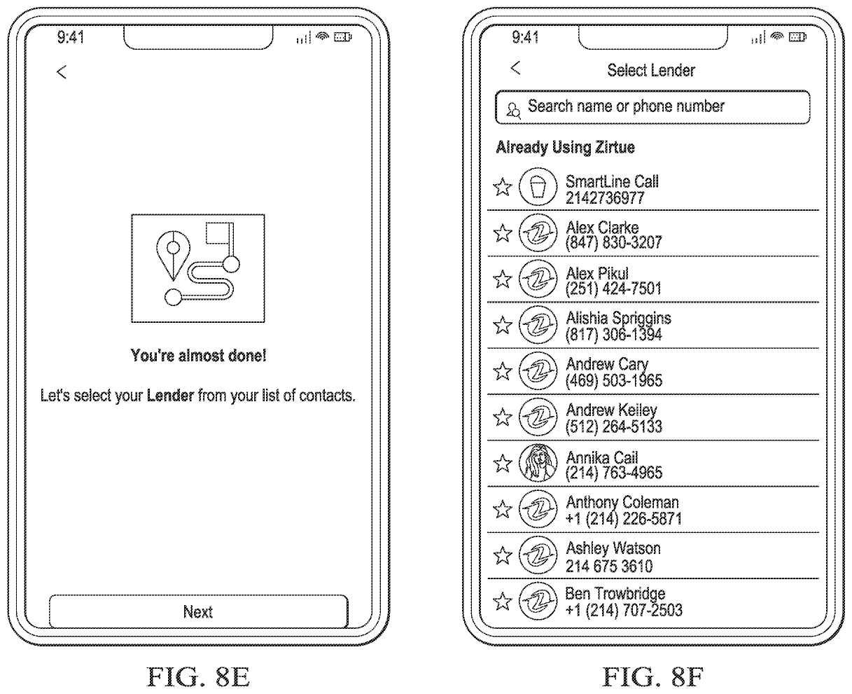

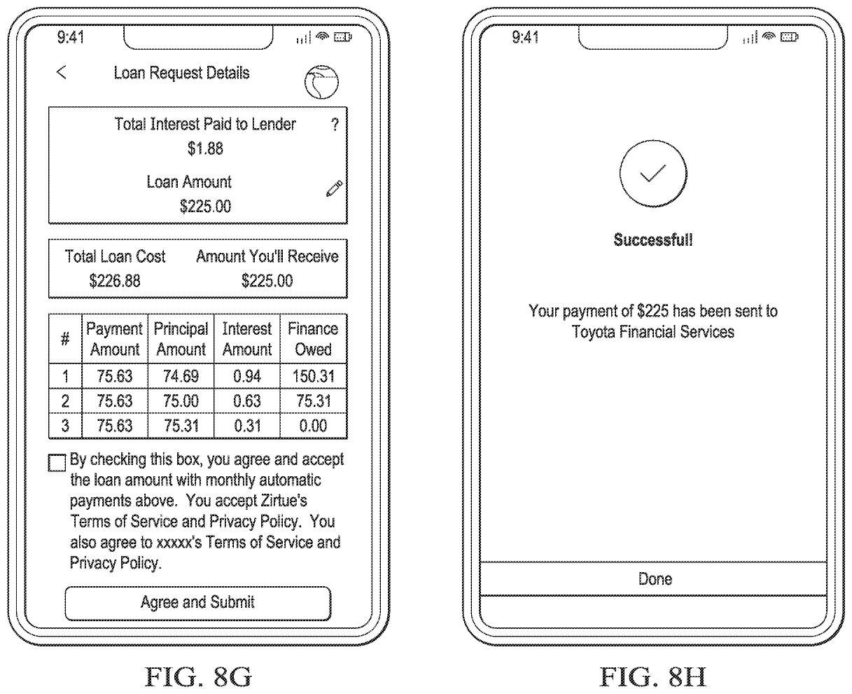

Turning now to FIGS. 8A-8H, another set of example user interfaces are shown depicting an embodiment of a borrower's use of an app, in accordance with some embodiments.

One of ordinary skill in the art with the benefit of this disclosure will understand that the preferred initialization point for the methods depicted in the various FIGURES and the order of the steps comprising those methods may depend on the implementation chosen. In these and other embodiments, such methods may be implemented as hardware, firmware, software, applications, functions, libraries, or other instructions. Further, although such the FIGURES may disclose a particular number of steps to be taken with respect to each disclosed method, the method may be executed with greater or fewer steps than depicted. The method may be implemented using any of the various components disclosed herein (such as the components of FIG. 1), and/or any other system operable to implement the method.

Although various possible advantages with respect to embodiments of this disclosure have been described, one of ordinary skill in the art with the benefit of this disclosure will understand that in any particular embodiment, not all of such advantages may be applicable. In any particular embodiment, some, all, or even none of the listed advantages may apply.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

1. An information handling system comprising:
at least one processor; and
a non-transitory memory coupled to the at least one processor;
wherein the information handling system is configured to:
receive, from a borrowing party, a request for a loan from a lending party for servicing a debt owed to a creditor party;
receive, from the borrowing party, information regarding a backup lending party;
transmit, to the lending party, information relating to the request;
determine loan repayment terms;
in response to the lending party agreeing to make the loan:
cause a first amount of funds to be debited from the lending party in a first transaction; and
cause a second amount of funds to be credited to the creditor party in a second transaction; and
in response to the lending party declining to make the loan:
transmit, to the backup lending party, information relating to the request;
determine backup loan repayment terms;
cause the first amount of funds to be debited from the backup lending party in a first transaction; and
cause the second amount of funds to be credited to the creditor party in a second transaction.

2. The information handling system of claim 1, wherein the request is initiated via a mobile application used by the borrowing party.

3. The information handling system of claim 1, wherein the information relating to the request is transmitted to a mobile application used by the lending party.

4. The information handling system of claim 1, wherein the first amount of funds and the second amount of funds are equal.

5. The information handling system of claim 1, wherein the information handling system is further configured to deduct funds periodically from the borrowing party in accordance with the loan repayment terms.

6. The information handling system of claim 5, wherein the loan repayment terms include an interest amount.

7. The information handling system of claim 1, wherein the loan repayment terms are specified by the request for the loan.

8. A method comprising:
an information handling system receiving, from a borrowing party, a request for a loan from a lending party for servicing a debt owed to a creditor party;
the information handling system receiving, from the borrowing party, information regarding a backup lending party;
the information handling system transmitting, to the lending party, information relating to the request;
the information handling system determining loan repayment terms;
in response to the lending party agreeing to make the loan:
the information handling system causing a first amount of funds to be debited from the lending party in a first transaction; and
the information handling system causing a second amount of funds to be credited to the creditor party in a second transaction; and
in response to the lending party declining to make the loan:
the information handling system transmitting, to the backup lending party, information relating to the request;
the information handling system determining backup loan repayment terms;
the information handling system causing the first amount of funds to be debited from the backup lending party in a first transaction; and
the information handling system causing the second amount of funds to be credited to the creditor party in a second transaction.

9. The method of claim 8, wherein the first and second transactions are carried out via at least one linked bank account.

10. The method of claim 8, wherein the first and second transactions are carried out via at least one credit card.

11. The method of claim 8, wherein the first and second transactions are carried out via at least one debit card.

12. The method of claim 8, wherein the information handling system is further configured to generate a legally binding contract in accordance with the repayment terms for signature by the borrowing party and the lending party.

13. The method of claim 8, wherein the legally binding contract is configured to be electronically signed via a mobile application.

14. The information handling system of claim 13, wherein the mobile application is a smartphone application.

15. An article of manufacture comprising a non-transitory, computer-readable medium having instructions thereon that are executable by an information handling system for:
receiving, from a borrowing party, a request for a loan from a lending party for servicing a debt owed to a creditor party;
receiving, from the borrowing party, information regarding a backup lending party;
transmitting, to the lending party, information relating to the request;
determining loan repayment terms;
in response to the lending party agreeing to make the loan:
causing a first amount of funds to be debited from the lending party in a first transaction; and
causing a second amount of funds to be credited to the creditor party in a second transaction; and
in response to the lending party declining to make the loan:
transmitting, to the backup lending party, information relating to the request;
determining backup loan repayment terms;
causing the first amount of funds to be debited from the backup lending party in a first transaction; and
causing the second amount of funds to be credited to the creditor party in a second transaction.

16. The article of claim 15, wherein the loan repayment terms include at least one of a repayment amount, a repayment schedule, and an interest rate.

17. The article of claim 16, wherein the repayment schedule includes at least one of a one-time payment and a monthly repayment schedule.

18. The article of claim 15, the instructions further executable for:
receiving a counteroffer from the lending party in response to the request for the loan, wherein loan repayment terms of the counteroffer differ from the loan repayment terms of the request for the loan; and
transmitting information relating to the counteroffer to the borrowing party.

19. The article of claim 15, the instructions further executable for:
periodically sending reminders to the borrowing party regarding repayment of the loan.

20. (canceled)
